(19) United States
(12) Patent Application Publication
(10) Pub. No.: US 2026/0167042 A1
(43) Pub. Date: Jun. 18, 2026

(54) ELECTRIC VEHICLE CHARGING/DISCHARGING MANAGEMENT DEVICE AND METHOD

(71) Applicants: HYUNDAI MOTOR COMPANY, SEOUL (KR); KIA CORPORATION, SEOUL (KR)

(72) Inventors: Jae Yun Jung, Hwaseong-si (KR); Hyun Sup Kim, Hwaseong-si (KR); Min Kyu Lee, Hwaseong-si (KR); Jeong Hoon Choi, Hwaseong-si (KR); Na Yeon Park, Hwaseong-si (KR); Dae Gun Ko, Hwaseong-si (KR); Hye Seung Han, Hwaseong-si (KR); Sung Kyu Kim, Hwaseong-si (KR); Bum Su Park, Hwaseong-si (KR)

(73) Assignees: HYUNDAI MOTOR COMPANY, SEOUL (KR); KIA CORPORATION, SEOUL (KR)

(21) Appl. No.: 19/229,605

(22) Filed: Jun. 5, 2025

(30) Foreign Application Priority Data
Dec. 13, 2024 (KR) 10-2024-0185995

(51) Int. Cl. B60L 53/62; B60L 53/66; B60L 58/12

(52) U.S. Cl. CPC B60L 53/62; B60L 53/66; B60L 58/12

(57) ABSTRACT

An electric vehicle charging/discharging management device is provided. The device includes a communication unit configured to collect vehicle information and a driver's schedule, a first processing unit configured to learn a linked pattern according to the vehicle information and the driver's schedule, and a second processing unit configured to set a charging mode according to the linked pattern when the vehicle information and the driver's schedule are input.

### CROSS-REFERENCE TO RELATED APPLICATION(S)

This application claims benefit of priority to Korean Patent Application No. 10-2024-0185995 filed on Dec. 13, 2024, in the Korean Intellectual Property Office, the disclosure of which is incorporated herein by reference in its entirety.

### TECHNICAL FIELD

The present disclosure relates to an electric vehicle charging/discharging management device and method.

### BACKGROUND

As the spread of electric vehicles (EVs) has expanded in recent years, users of the electric vehicles have been able to control a charging process through a user interface (UI) that allows the user to set various variables related to vehicle charging. These variables include a charging start time, a charging end time, a charging power capacity, a charging mode, and the like, and the users can manually set these variables according to their needs. However, actual users often do not use this function due to lack of knowledge on how to optimize and use these settings or because it is inconvenient to manually set the variables every time.

A concern of electric vehicle users is battery deterioration. As electric vehicles are repeatedly charged and discharged, the battery life decreases, and this is affected by user's driving and charging habits. In particular, when vehicle-to-grid (V2G) services are activated, the batteries of electric vehicles may experience more frequent charging and discharging, which could increase battery deterioration. The V2G service is a technology that connects electric vehicles to the grid to enable energy storage and supply, which can be a factor that shortens the battery life.

### SUMMARY

The present disclosure is directed to providing an electric vehicle charging/discharging (e.g., charging and discharging) management device capable of automatically collecting data related to charging through real-time communication between an electric vehicle, a charger, and a database server, and automatically adjusting charging parameters based on the data.

Thus, a user can increase convenience and efficiency during a charging process, minimize battery deterioration, and protect battery life by optimizing a state-of-charge (SoC) range during charging and discharging, even when participating in V2G services.

According to an aspect of the present disclosure, there is provided an electric vehicle charging/discharging management device including a communication unit configured to collect vehicle information and a driver's schedule, a first processing unit (e.g. first processor) configured to learn a linked pattern according to the vehicle information and the driver's schedule, and a second processing unit (e.g., second processor) configured to set a charging mode according to the linked pattern when the vehicle information and the driver's schedule are input.

The vehicle information may include plug-in charger information, a current state of charge (SoC), a target SoC, source type information, battery capacity information, battery charging/discharging efficiency, expected vehicle entry time information, expected vehicle exit time information, a plug-in time, and a plug-out time.

The driver's schedule may include a driving schedule, time information, departure information, and destination information.

The first processing unit may output result data obtained by probabilistically inferring a correlation between a lifestyle pattern, a use pattern of a vehicle, and a charging/discharging pattern based on the driver's schedule as the linked pattern.

The second processing unit may independently set charging parameters for each charging mode.

The charging parameters may include a minimum battery amount and a target battery amount.

The second processing unit may set the charging mode for battery protection charging to a first charging mode according to the learned linked pattern.

The second processing unit may set the charging mode by comparing a vehicle usage probability according to the driver's schedule with a preset threshold value.

The second processing unit may set the charging mode by a location of the vehicle according to the driver's schedule and comparing a charging/discharging probability of the vehicle with a preset threshold value.

The second processing unit may set the charging mode by comparing a probability of use of the vehicle according to the driver's schedule and a probability for a vehicle traveling distance with a preset threshold value.

According to another aspect of the present disclosure, there is provided an electric vehicle charging/discharging management method including collecting, by a communication unit, vehicle information and a driver's schedule, learning, by a first processing unit, a linked pattern according to the vehicle information and the driver's schedule, and setting, by a second processing unit, a charging mode according to the linked pattern when the vehicle information and the driver's schedule are input.

The vehicle information may include plug-in charger information, a current SoC, a target SoC, source type information, battery capacity information, battery charging/discharging efficiency, expected vehicle entry time information, expected vehicle exit time information, a plug-in time, and a plug-out time.

The driver's schedule may include a driving schedule, time information, departure information, and destination information.

The first processing unit may output result data obtained by probabilistically inferring a correlation between a lifestyle pattern, a use pattern of a vehicle, and a charging/discharging pattern based on the driver's schedule as the linked pattern.

The second processing unit may independently set charging parameters for each charging mode.

The charging parameters may include a minimum battery amount and a target battery amount.

The second processing unit may set the charging mode for battery protection charging to a first charging mode according to the learned linked pattern.

The second processing unit may set the charging mode by comparing a vehicle usage probability according to the driver's schedule with a preset threshold value.

The second processing unit may set the charging mode by a location of the vehicle according to the driver's schedule and comparing a charging/discharging probability of the vehicle with a preset threshold value.

The second processing unit may set the charging mode by comparing a probability of use of the vehicle according to the driver's schedule and a probability for a vehicle traveling distance with a preset threshold value.

The method may further include a user interface unit configured to provide a function of setting the parameters of the charging mode.

### BRIEF DESCRIPTION OF THE DRAWINGS

The above and other objects and features of the present disclosure will become more apparent by describing exemplary embodiments thereof in detail with reference to the accompanying drawings.

FIG. 1 is a view for describing an electric vehicle power management system according to an embodiment.

FIG. 2 is a block diagram of an electric vehicle charging/discharging management device according to an embodiment.

FIG. 3 is a view for describing the operation of the electric vehicle charging/discharging management device according to an embodiment.

FIG. 4 is a view for describing a driver's schedule according to an embodiment.

FIG. 5 is a view for describing the operation of a second processing unit according to an embodiment.

FIG. 6 is a view for describing the operation of a user interface unit according to an embodiment.

FIG. 7 is a conceptual diagram of the operation of the electric vehicle charging/discharging management device according to an embodiment.

FIG. 8 is a flowchart of an electric vehicle charging/discharging management method according to an embodiment.

### DETAILED DESCRIPTION

Exemplary embodiments of the present disclosure will be described in detail below with reference to the accompanying drawings.

However, the present disclosure is not limited to the embodiments described, but may be implemented in various different forms, and within the scope of the present disclosure, one or more of the components among the embodiments may be selectively combined or substituted and used.

In addition, the terms used in the embodiments of the present disclosure may be interpreted as having meanings that are generally understood by a person of ordinary skill in the technical field to which the present disclosure belongs, unless defined and described, and commonly used terms such as terms defined in dictionaries may be interpreted in consideration of their contextual meaning in the art.

Additionally, the terms used in the embodiments of the present disclosure are for the purpose of describing the embodiments and are not intended to limit the present disclosure.

In this specification, the singular may also include the plural unless the context clearly dictates otherwise, and when described as “at least one (or one or more) of A, B, and C,” it may include one or more of all possible combinations of A, B, and C.

Additionally, in describing components of embodiments of the present disclosure, terms such as first, second, A, B, (a), (b), or the like may be used.

These terms are intended to distinguish one component from another, and are not intended to limit the nature, order, or sequence of the component.

In addition, when a component is described as being “connected,” “coupled,” or “linked” to another component, it may include cases in which the component is directly connected, coupled, or linked to the other component, and also cases in which the component is “connected,” “coupled,” or “linked” by another component between the component and the other component.

Additionally, when a component is described as being formed or disposed on “on (above) or below (under)” another component, “above” or “below” includes cases in which the two components are in direct contact with each other, and also cases in which one or more other components are formed or disposed between the two components. Additionally, when expressed as “above or below,” it can include the meaning of the upward direction and also the downward direction based on one component.

Hereinafter, embodiments will be described in detail with reference to the attached drawings. Regardless of the drawing numbers, identical or corresponding components are given the same reference numerals, and redundant descriptions thereof may be omitted.

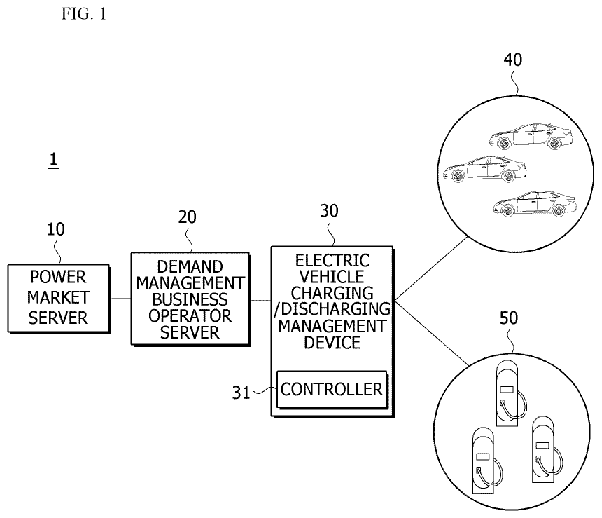

FIG. 1 is a view of an electric vehicle power management system according to an embodiment. Referring to FIG. 1, the electric vehicle power management system 1 may include a power market server 10, a demand management business operator server 20, and an electric vehicle charging/discharging management device 30.

The power market server 10 is an entity that operates a power market and may perform settlement according to a participation amount for each source in different ways according to market settlement rules. The power market server 10 may mediate power transactions between demand management business operator servers 20 using power transaction request information received from a plurality of demand management business operator servers 20.

The power market server 10 may be a server that contracts with a demand management business operator for an amount of power usage and an amount of discharge business and distributes profits to the demand management business operator through demand response and a time-based power unit price.

The demand management business operator server 20 may perform power transactions using charging/discharging information received from the linked electric vehicle charging/discharging management device 30, renewable energy generation amount information of a linked renewable energy generation system, and power demand information of a linked system.

In an example embodiment, the demand management business operator may refer to a business operator who contracts with places that use large amounts of power, such as factories, large buildings and parking towers, to reduce power consumption according to demand response, and thus gains profits.

A power system linked to the demand management business operator may transmit the power demand information to the demand management business operator server 20 at a preset cycle, at the request of the demand management business operator server, or when necessary. The power demand information may include an amount of hourly power demand and power usage reduction demand for the linked system.

The demand management business operator server 20 may respond to demand response through a request to reduce the amount of power usage, and also perform a role similar to a power plant that transmits power that may be used directly in the grid using electric vehicles 40, electric vehicle batteries, ESSs, or the like.

For example, the demand management business operator server 20 may receive the next day's charging/discharging amount of the electric vehicle charging/discharging management device 30 at a specific time every day and bidding may be made on the power market server side, and the contracted amount may be received from the power market server 10 according to a preset cycle and transmitted to the electric vehicle charging/discharging management device 30.

The electric vehicle charging/discharging management device 30 (e.g., directly) manages electric vehicles 40 and charging stations 50 of customers participating in a V2X service, and may receive information on the electric vehicles 40 and chargers, plug-in/out signals, and the like. The electric vehicle charging/discharging management device 30 may determine the next day's charging/discharging bid amount with the goal of maximizing market participation profits, and may control the charging/discharging of the individual electric vehicles 40 to fulfill the contracted amount.

The electric vehicle charging/discharging management device 30 may monitor information on the electric vehicles 40 and the charging stations 50 and may provide various types of data for customers. The electric vehicle charging/discharging management device 30 may perform functions such as billing settlement, parking space management, generation and transmission of charging/discharging control commands, charging/discharging scenario control, and vehicle battery status diagnosis.

The electric vehicle charging/discharging management device 30 may include a controller 31.

The power system may include smart grid-related systems such as, for example, a substation, a power market server, a demand management business operator server, renewable sources, or an energy storage system (ESS). The renewable sources may be wind, solar, geothermal, or waste-based energy sources. The power system may supply power within a range of allowable power (or maximum power (Pmax) or allowable AC current (IACmax)) to the charging stations 50 under the control of the controller 31.

In some cases, when a large number of electric vehicles 40 are concentrated at charging stations 50 in a specific region at the same time, the maximum allowable power of the power system may vary. That is, the power market server 10 that controls a system operation, the demand management business operator server 20 or an energy management system (EMS) may deploy a reserve power source such as an energy storage system (ESS) or may deploy a surrounding renewable energy source to increase a power capacity and supply the power to the charging stations.

The allowable power may be increased by the control of the controller 31 when the power supplied to the electric vehicles 40 is insufficient due to charging demand information of each electric vehicle 40 (e.g., a charging demand amount of electric vehicle users). That is, the controller 31 may control a switch to additionally connect (deploy) a renewable energy source (or the energy storage system (ESS)) within the power system to the substation that supplies power to the charging stations 50 so that the allowable power of the power system increases when a charging load (e.g., a load of the electric vehicle) of the charging station 50 exceeds the allowable power of the power system.

The controller 31 may control the overall operation of components included in the electric vehicle charging/discharging management device 30. The controller 31 is an aggregator and may collect information on a battery capacity of the electric vehicle 40 connected to the charging station 50 through a wired or wireless communication network, a state of charge (SoC) of the battery of the electric vehicle 40, a rated current flowing through a power line, a rated voltage applied to the power line, or charging request information of an electric vehicle user (e.g., an owner). The charging request information of the electric vehicle user may be transmitted to the controller 31 through a communication unit included in each of the charging stations 50 or through a communication unit, such as a mobile phone of the user.

The controller 31 may exchange information with the power system through a wired or wireless communication network, and may exchange data with the charging station 50 through a LAN connection such as Ethernet, power line communication (PLC), or Wi-Fi, which is a wired or wireless communication network.

The controller 31 may control the power of the power system to be supplied to the charging station 50 within an allowable power range of the power system based on real-time information of the power system, status information of the electric vehicles 40, and charging demand information of each electric vehicle 40.

The real-time information of the power system may include the allowable power information of the power system or the electricity rate information of the power system, the status information of the electric vehicle 40 may include the SoC information of the battery included in each electric vehicle 40, and the charging demand information may include a charging demand time of the electric vehicle user, an expected vehicle entry time, an expected vehicle exit time, and a charging demand amount (e.g., a target SoC).

Each of the charging stations 50 may charge the batteries of a plurality of electric vehicles 40. Each of the charging stations 50 may include an AC current limiter that performs a current allocation operation for each of the electric vehicles 40. Additionally, each of the charging stations 50 may include a control module that exchanges information with the battery management system (BMS) of the electric vehicle 40 and the controller 31. Due to the control of the controller 31, the control module may control the current limiter (e.g., the AC current limiter) to provide a DC charging current to each of the batteries of the electric vehicles 40.

Each of the electric vehicles 40 may include a battery management system (BMS). The battery management system may control a battery charging process. Each of the electric vehicles 40 may function as an active load that requests power from the electric vehicle charging/discharging management device 30 during a charging time.

A charger that converts an alternating current of the power system into direct current to charge the battery of the electric vehicle 40 may be an on-board charger included in each electric vehicle 40 or an off-board charger included in each charging station 50.

The electric vehicles 40 may participate in power transactions by registering on a V2X platform. The users of the electric vehicles 40 may join the platform according to the power market they wish to participate in and may register their expected vehicle entry and exit schedules for the next day. The electric vehicles 40 may transmit information such as an expected plug-in time, an expected plug-out time, SoC information, and available battery capacity to the electric vehicle charging/discharging management device 30.

The electric vehicle power management system 1 described above is a centralized control system that may adjust the charging/discharging schedule of the electric vehicles by considering hourly power prices or demand and supply of the power system. However, as the number of electric vehicles to be controlled increases, computational burden and complexity for optimal scheduling may increase.

The electric vehicle charging/discharging management device according to an example embodiment may be able to optimize the charging/discharging of a large-scale electric vehicle fleet.

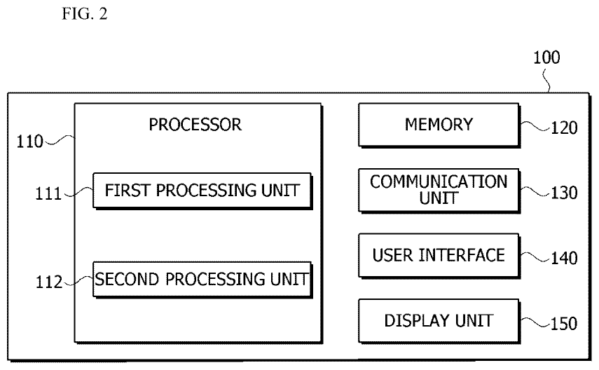

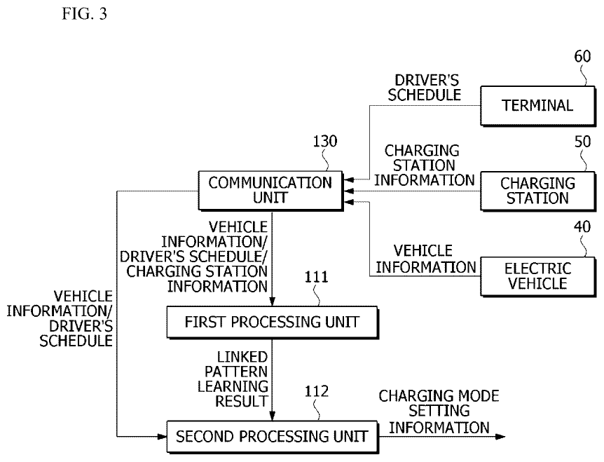

FIG. 2 is a block diagram of the electric vehicle charging/discharging management device according to an embodiment, and FIG. 3 is a view for describing an operation of the electric vehicle charging/discharging management device according to an embodiment.

Referring to FIGS. 2 and 3, the electric vehicle charging/discharging management device 100 may include a processor 110, a memory 120, a communication unit 130, a user interface unit 140, and a display unit 150. In addition, the processor 110 according to the example embodiment may include a first processing unit 111 and a second processing unit 112.

The electric vehicle charging/discharging management device 100 according to the example embodiment may be implemented in a logic circuit by hardware, firmware, software or a combination thereof, and may also be implemented using a general-purpose or special-purpose computer. The apparatus may be implemented using hardwired devices, field programmable gate arrays (FPGAs), application specific integrated circuits (ASICs), or the like. Additionally, the device 100 may be implemented as a system on chip (SoC) including one or more processors and controllers.

The electric vehicle charging and discharging management device 100 may be embodied as a dedicated computing device or system configured to manage the charging and discharging operations of electric vehicles. For example, the management device 100 may be implemented as an onboard control unit integrated within the electric vehicle, a standalone server located at a charging station, or a cloud-based computing platform communicating with the electric vehicle and charging station via a network. In some embodiments, the management device may comprise a combination of these forms, such as a distributed system where an onboard processor collaborates with a remote server to execute the charging and discharging management functions. These implementations are provided as non-limiting examples, and the management device 100 may encompass other hardware or software configurations capable of performing the operations described herein, including collecting vehicle information, learning linked patterns, and setting charging modes.

In addition, the electric vehicle charging/discharging management device 100 may be installed in a computing device or server equipped with hardware elements in the form of software, hardware, or a combination thereof. The computing device or server may refer to various devices including all or part of a communication device such as a communication modem for communicating with various devices or wired/wireless communication networks, a memory for storing data for executing a program, a microprocessor for executing a program to perform calculations and instructions, and the like.

The memory 120 may include a database (DB). The memory 120 may be a non-transitory storage medium that stores instructions executed by the processor 110. The memory 120 may include at least one of storage media such as a random access memory (RAM), a static random access memory (SRAM), a read only memory (ROM), a programmable read only memory (PROM), an electrically erasable and programmable ROM (EEPROM), an erasable and programmable ROM (EPROM), a hard disk drive (HDD), a solid state disk (SSD), an embedded multimedia card (eMMC), a universal flash storage (UFS), and/or a web storage.

The processor 110 may include at least one processing device such as an application specific integrated circuit (ASIC), a digital signal processor (DSP), a programmable logic device (PLD), a field programmable gate array (FPGA), a central processing unit (CPU), a microcontroller, and/or a microprocessor.

Additionally, each function of the processor may be implemented and operated by a module, and the operation thereof may be determined by turning each module on/off according to a user's settings.

In the example embodiment, the electric vehicle charging/discharging management device 100 may receive vehicle information and a driver's schedule through the communication unit 130 and store them in the memory 120.

The communication unit 130 performs data communication with a driver's terminal 60, an electric vehicle 40, and a charging station 50 participating in the V2X service, and may receive the vehicle information, the driver's schedule, and the like.

In the example embodiment, the vehicle information may include plug-in charger information, present SoC, target SoC, source type information, battery capacity information, and battery charging/discharging efficiency, expected vehicle entry time information, expected vehicle exit time information, and actual plug-in time and plug-out time information.

Additionally, the vehicle information may include a system marginal price (SMP) and a contracted power capacity (CPC).

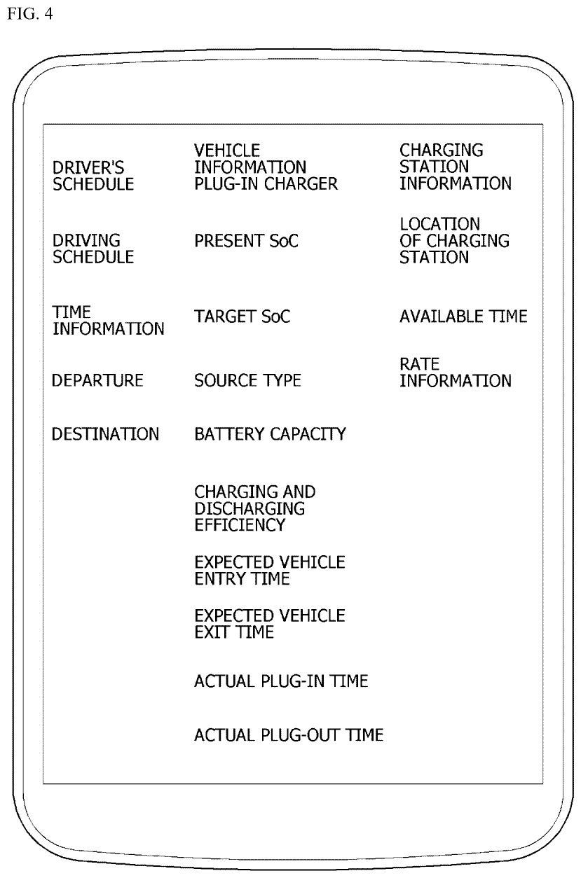

FIG. 4 is a view for describing the driver's schedule according to an embodiment. Referring to FIG. 4, the driver's schedule may include a driving schedule, time information, departure information, and destination information. The driver's schedule may be collected by date or hour, and may include the driving schedule, the time information, the departure information, and the destination information in detailed hourly units. The driving schedule may include information on times when a driver is scheduled to use a vehicle.

Additionally, the departure information may include departure location and departure time information.

Additionally, the destination information may include destination location and expected destination arrival time information.

For example, the communication unit 130 may collect the driver's schedule from a calendar app (e.g., application), schedule information, work schedule, and the like, which are installed on the vehicle driver's terminal.

Additionally, the communication unit 130 may collect charging station information from charging stations located on a driving route between a departure and a destination according to the driver's schedule.

The charging station information may include a charging station location, available time, and rate information, and the like.

The communication unit 130 may collect the vehicle information and the driver's schedule at regular time intervals or may collect them in real time when the information changes.

The first processing unit 111 may learn a linked pattern according to the vehicle information and the driver's schedule.

The first processing unit 111 may remove or correct missing values and error data in the collected vehicle information and driver's schedule.

The first processing unit 111 may extract (e.g., meaningful) characteristic data to create input data that may be used for learning the linked pattern in the vehicle information and the driver's schedule. The first processing unit 111 may align the driver's schedule, vehicle usage information, and charging/discharging information along a common time axis and convert them into time series data. The first processing unit 111 may organize the aligned data into units by normalization.

The first processing unit 111 may extract (e.g., important) characteristics from each type of data. For example, characteristics may be a driving distance, an average speed, a charging cycle, and whether to charge the vehicle after driving.

The first processing unit 111 may create composite characteristics to clarify the relationship between the driver's schedule, vehicle use, and charging/discharging. For example, it is possible to create new characteristics such as “charging right after commuting to work” or “need for charging after a long drive.”

The first processing unit 111 may probabilistically express the dependency between the driver's schedule, the vehicle usage pattern, and the charging/discharging data using a Bayesian network. The first processing unit 111 may learn the correlation between schedule, vehicle use, and charging/discharging events by calculating conditional probabilities using a Bayesian network model.

Alternatively, the first processing unit 111 may predict a future pattern based on past data and a current status using a recurrent neural network (RNN) or long short-term memory (LSTM). The first processing unit 111 learns the time series relationship between the driver's schedule, vehicle use, and charging/discharging data using RNN and LSTM models, and may identify the correlation between events that occur in specific time slots or situations.

Alternatively, the first processing unit 111 may learn a transition probability between states (for example, a vehicle use state, a charging state, and the like) using a hidden Markov model (HMM). The first processing unit 111 may analyze how vehicle usage patterns and charging/discharging patterns change according to a change in the driver's schedule using the HMM.

The first processing unit 111 may train a model by inputting the normalized driver's schedule, vehicle use, and charging/discharging data in chronological order. The learning model of the first processing unit 111 learns a probability of each event occurring, and may identify the correlation between vehicle use and charging/discharging according to the schedule.

The first processing unit 111 may evaluate the performance of the learning model, perform cross-validation to obtain optimal performance, and adjust hyperparameters.

The first processing unit 111 may probabilistically derive the correlation between the driver's schedule, the vehicle usage pattern, and the charging/discharging pattern using the learning model. For example, the first processing unit 111 may learn and predict a pattern in which the need for charging increases according to a driving distance after commuting to work.

The first processing unit 111 evaluates the prediction performance of the model by comparing real-time data with prediction results, and when new data is collected, it may be reflected in model learning to improve prediction performance.

Thus, the first processing unit 111 may learn the connection between the driver's schedule, the vehicle usage pattern, and the charging/discharging pattern, and may produce probability information accordingly.

For example, the first processing unit 111 may learn that there is a high correlation between a business trip and vehicle use when a driver has a business trip scheduled for the next day and the vehicle is frequently used.

For example, the first processing unit 111 may learn that there is a high correlation between a business trip and vehicle charging/discharging when the driver has a business trip scheduled for the next day and the vehicle is frequently charged and discharged.

For example, the first processing unit 111 may learn that there is a high correlation between commuting to work and vehicle use when the driver is scheduled to go to work the next day and the vehicle is frequently used.

For example, the first processing unit 111 may learn that there is a high correlation between a schedule of not going out and the charging/discharging of the vehicle when the driver is not scheduled to go out the next day and the vehicle is frequently charged and discharged.

The first processing unit 111 may probabilistically infer the correlation between the driver's schedule, the vehicle usage pattern, and the charging/discharging pattern, and may provide results thereof in numerical form.

At this time, the first processing unit 111 may organize linked patterns in order of high correlation according to the probability and provide them to the second processing unit 112.

The second processing unit 112 may set a charging mode according to the learned linked pattern when the vehicle information and the driver's schedule are input. The second processing unit 112 may predict the vehicle use and the need for charging/discharging according to the collected driver's future schedule. Based on this, the second processing unit 112 may establish a charging/discharging plan by selecting the charging mode according to the predicted correlation.

For example, the second processing unit 112 may use the trained model to predict an optimal charging time and location based on a specific schedule.

Alternatively, the second processing unit 112 may create an optimal charging plan by taking into account energy costs, charging time, and the congestion of the charging station using the predicted charging time and location.

In addition, the second processing unit 112 may dynamically change the charging mode by reflecting a change in a vehicle location, a change in the schedule, and a change in a charging station status in the learning model through the vehicle information, the driver's schedule, and the charging station information that are updated in real time.

In addition, the second processing unit 112 may compare actual charging results with predictions of the learning model to analyze differences therebetween and (e.g., continuously) improve the prediction performance by reflecting feedback data in the model learning.

The second processing unit 112 may derive the linked pattern according to the vehicle information and the driver's schedule using the learning model of the first processing unit 111 and set the charging mode according to the linked pattern.

In the embodiment, the linked pattern may be result data obtained by probabilistically inferring the correlation between the lifestyle pattern, the vehicle usage pattern, and the charging/discharging pattern according to the driver's schedule, and may provide (e.g., mean) data in which the correlation between detailed actions that constitute each pattern is derived as a probabilistic value.

The second processing unit 112 may (e.g., independently) set charging parameters for each charging mode. The charging parameters may include a minimum battery amount and a target battery amount. The second processing unit 112 may set the minimum battery amount and the target battery amount for each charging mode. In addition, the second processing unit 112 may set a charging/discharging limit range for each charging mode.

The second processing unit 112 may probabilistically infer the vehicle usage pattern and the charging/discharging pattern according to the driver's schedule and lifestyle, and may set the charging mode using the probabilistically inferred vehicle usage pattern and charging/discharging pattern.

The second processing unit 112 may set the charging mode using the linked pattern whose probability exceeds a preset threshold value.

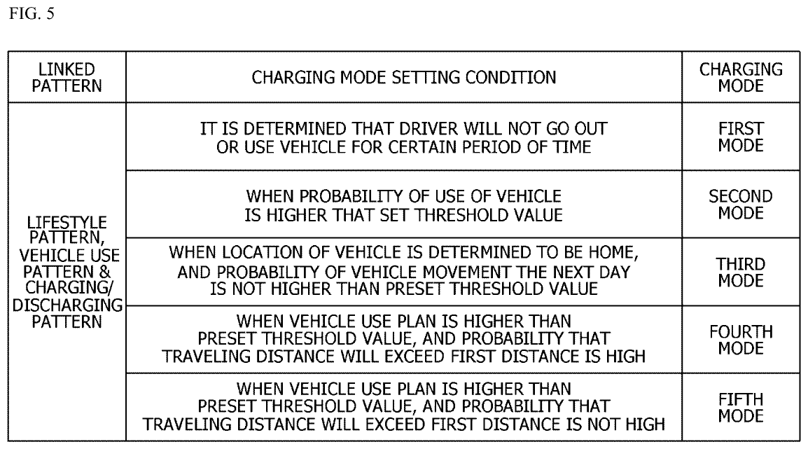

FIG. 5 is a view for describing the operation of the second processing unit according to an embodiment. Referring to FIG. 5, the second processing unit 112 may enter a battery first mode for battery protection charging according to the learned linked pattern. The second processing unit 112 may enter the first mode and perform battery protection charging when it is determined that the driver will not go out or will not use the vehicle for a certain period of time with a probability higher than a preset threshold value by taking into account the driver's lifestyle pattern, the vehicle use pattern, and the charging/discharging pattern through the linked pattern. The first mode is a charging mode for extending the battery life through battery conditioning, and the second processing unit 112 may set a minimum battery amount of the first mode for the battery protection charging to 50% and the charging/discharging range limit to 20%.

For example, the second processing unit 112 may set the charging mode using the vehicle location and a vehicle traveling plan included in the linked pattern. That is, when the probability of use of the vehicle is higher than a preset threshold value from the linked pattern output from the learning model, the second processing unit 112 may determine a traveling route and time of the vehicle, and set the charging mode according to the determined traveling route and time. For example, the second processing unit 112 may set the charging mode to a second mode when the linked pattern includes a business trip or travel plan for the next day. The second processing unit 112 may set the target battery amount of the second mode to 95% and the minimum battery amount to 80%. That is, the second processing unit 112 may set the charging mode so that the electric vehicle can reach a business trip or travel destination when a business trip or travel is scheduled.

In addition, the second processing unit 112 may set the charging mode to a third mode when the location of the vehicle is determined to be home in the linked pattern and the probability of vehicle movement the next day is not higher than a preset threshold value. The second processing unit 112 may set the target battery amount of the third mode to 80% and the minimum battery amount to 20%. That is, the second processing unit 112 may set the charging mode so that the battery is charged at an appropriate level in the case of a vehicle that is parked at home and is not scheduled to go on a business trip or travel.

For example, the second processing unit 112 may set the charging mode using a distance to the destination calculated using the linked pattern. That is, the second processing unit 112 may determine a traveling distance of the vehicle from the linked pattern output from the learning model and set the charging mode according to the determined traveling distance. For example, the second processing unit 112 may set the charging mode to a fourth mode when the vehicle usage plan in the linked pattern is higher than a preset threshold value and there is a high probability that the traveling distance will be greater than a first distance.

Alternatively, the second processing unit 112 may set the charging mode to a fifth mode when the vehicle usage plan in the linked pattern is higher than the preset threshold value and the probability that the traveling distance will be greater than the first distance is not high. The second processing unit 112 may set the target battery amount of the fifth mode to 80% and the minimum battery amount to 20%. Additionally, the second processing unit 112 may set the target battery amount of the fourth mode to 95% and the minimum battery amount to 80%. That is, the second processing unit 112 may set the charging mode so that the vehicle can travel the corresponding distance by taking into account the traveling distance.

The user interface unit 140 may generate input data for controlling the operation of the electric vehicle charging/discharging management device 100. The user interface unit 140 may be configured as a keypad, a dome switch, a touch pad, a jog wheel, a jog switch, or the like. When the display unit 150 and the touch pad (e.g., the user interface 140) are configured as a touch screen with a mutually layered structure, the display unit 150 may be used as an input device in addition to an output device.

The user interface unit 140 may receive various commands for the operation of the electric vehicle charging/discharging management device.

For example, the user interface unit 140 may provide a function for setting parameters of the charging mode. Thus, the driver may set the minimum battery amount and target battery amount for each charging mode through the user interface unit 140.

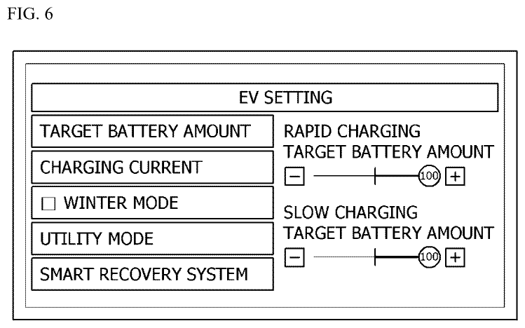

FIG. 6 is a view for describing the operation of the user interface unit according to an embodiment. Referring to FIG. 6, the electric vehicle charging/discharging management device may provide a screen for setting a target battery amount for charging in a charging mode through the user interface unit. The user interface unit may provide a setting screen through an app (application) on the driver's terminal or through the display unit.

The display unit 150 may include at least one of a liquid crystal display (LCD), a thin film transistor-liquid crystal display (TFT LCD), an organic light-emitting diode (OLED), a flexible display, a 3D display, and an e-ink display.

Additionally, the display unit 150 can output various user interfaces or graphical user interfaces on the screen.

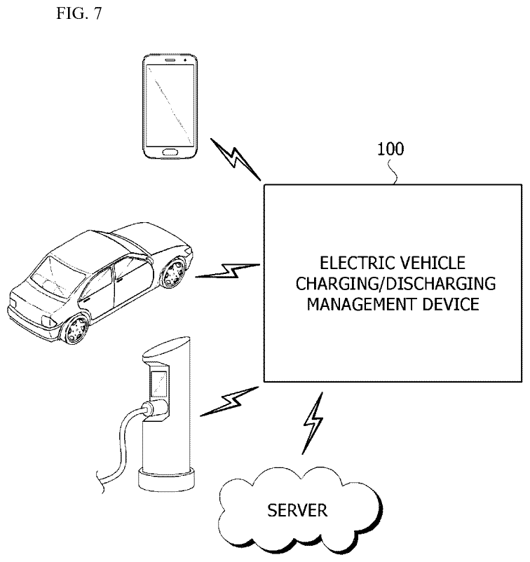

FIG. 7 is a conceptual diagram of the operation of the electric vehicle charging/discharging management device according to an embodiment. Referring to FIG. 7, the electric vehicle charging/discharging management device 100 according to the embodiment may collect the driver's schedule through the driver's terminal, learn the driver's schedule and the vehicle information, and automatically establish a charging/discharging plan for the vehicle according to the linked pattern. This is intended to automatically set an optimized charging/discharging strategy by learning the driver's schedule and lifestyle pattern. Thus, it is possible to maximize driver convenience, extend a vehicle's battery life, and reduce energy costs.

First, the electric vehicle charging/discharging management device 100 may collect a driver's daily schedule (for example, a morning commute time, an afternoon commute time, a regular travel schedule) and lifestyle pattern information (for example, weekend rest, shopping time, or the like) through the app of the linked driver's terminal.

In addition, the electric vehicle charging/discharging management device 100 may collect vehicle location information (GPS) and a driving pattern (for example, a driving route, an average driving distance, a driving speed).

Additionally, the electric vehicle charging/discharging management device 100 may collect the vehicle information from the electric vehicle and the charging station.

In addition, the electric vehicle charging/discharging management device 100 may collect weather information of a region in which the vehicle is located, power supply rates for each time slot (for example, peak time and/or off-peak time), or the like from a domestic meteorological administration server and the demand management business operator server.

The electric vehicle charging/discharging management device 100 may learn the linked pattern according to the collected vehicle information and driver's schedule, and when the vehicle information and the driver's schedule are input, it may calculate a charging plan according to the charging mode based on the linked pattern.

The electric vehicle charging/discharging management device 100 may predict when the driver will use the vehicle based on the linked pattern and the driver's schedule, and establish a charging plan accordingly. For example, when the driver leaves for work at 7 AM every morning, the vehicle can be scheduled to complete charging during the off-peak time of the previous night.

When a long drive is predicted, it will provide (e.g., ensure) that the battery is fully charged before departure, and when (e.g., only) a short drive is determined (e.g., needed), the device 100 may adjust the charging so as not to fully charge the battery, for the sake of battery durability.

When these charging plans are made based on the learned linked pattern, the processor may establish a charging plan by distinguishing the charging mode.

The electric vehicle charging/discharging management device 100 may adjust the charging/discharging plan according to the driver's preference through the user interface unit. For example, the user may set a maximum charging limit when he/she wants his/her vehicle to be fully charged, or to protect the battery.

Like a routine function, the user may automate charging or discharging actions according to specific events (for example, arrival at a specific location, a specific time slot, and the like).

The electric vehicle charging/discharging management device 100 may send a notification to the driver when the charging plan is in progress or when an unexpected situation occurs (for example, when the driver has to leave earlier than expected). Additionally, it is possible to provide an immediate action option so that the user may change the plan himself/herself.

The electric vehicle charging/discharging management device 100 according to the example embodiment may learn a driver's behavior over time and continuously optimize the charging plan. In this process, artificial intelligence (AI) and machine learning algorithms may be used to build better prediction models and adapt to changes in user habits.

For example, if the user has recently started to take frequent weekend travels, the electric vehicle charging/discharging management device 100 may recognize this and charge the battery in advance according to the schedule.

In addition, the electric vehicle charging/discharging management device 100 may establish a charging plan to complete charging during the cheapest possible time slot by taking into account fluctuations in power rates.

Additionally, a battery management strategy may be applied to prevent unnecessary overcharging or excessive discharging by setting a battery protection charging mode. For example, the battery charge level may be appropriately maintained to optimize battery life when the vehicle is not used for a long period of time.

For example, the electric vehicle charging/discharging management device 100 may establish a plan to start charging at 11:00 PM the night before and complete charging by 6:00 AM for a driver who leaves for work at 7:00 AM every day. Charging time slots may be given priority when power rates are low. At this time, the electric vehicle charging/discharging management device 100 may establish a charging plan by setting a charging mode optimized for the daily commuting routine.

For example, when a driver frequently travels a long-distance every weekend, the electric vehicle charging/discharging management device 100 may learn this and plan to charge the battery as much as possible by Saturday morning. Additionally, it is possible to set up a charging plan to supply power to the driver's home during a peak power time slot with any remaining battery when the driver returns home from a trip.

This disclosure reduces the complexity of charging/discharging, and allows electric vehicle users to use their vehicles in an economical and efficient manner. As a result, it is possible to increase user convenience and satisfaction while extending battery life and reducing energy costs.

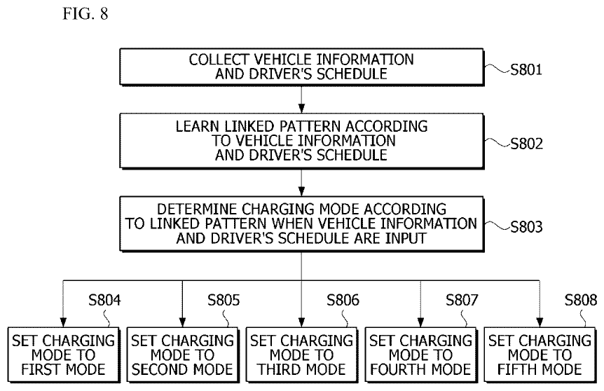

FIG. 8 is a flowchart of an electric vehicle charging/discharging management method according to an embodiment.

Referring to FIG. 8, first, the communication unit collects vehicle information and the driver's schedule (S801).

Next, the first processing unit learns the linked pattern according to the vehicle information and the driver's schedule. For example, the first processing unit may output result data obtained by probabilistically inferring the correlation between the lifestyle pattern, the vehicle usage pattern, and the charging/discharging pattern based on the driver's schedule as the linked pattern (S802).

Next, the second processing unit determines the charging mode according to the linked pattern when the vehicle information and the driver's schedule are input (S803).

For example, the second processing unit may enter the first mode and perform battery protection charging when it is determined that the driver will not go out or use the vehicle for a certain period of time with a probability higher than a preset threshold value by taking into account the driver's lifestyle pattern, vehicle use pattern, and charging/discharging pattern through the linked pattern (S804).

For example, the second processing unit may set the charging mode to the second mode when the probability of use of the vehicle is higher than a preset threshold value, such as when a business trip or travel plan for the next day is included in the linked pattern output from the learning model (S805).

For example, the second processing unit may set the charging mode to the third mode when the location of the vehicle is determined to be home in the linked pattern and the probability of vehicle movement the next day is not higher than a preset threshold value (S805).

For example, the second processing unit may set the charging mode to the fourth mode when the vehicle usage plan in the linked pattern is higher than a preset threshold value and there is a high probability that the traveling distance will be greater than the first distance (S806).

For example, the second processing unit may set the charging mode to the fifth mode when the vehicle usage plan in the linked pattern is higher than a preset threshold value and the probability that the traveling distance will exceed the first distance is not high (S807).

The term “˜unit” used in this embodiment may be software or hardware components such as a field-programmable gate array (FPGA) or ASIC, and the “˜unit” may perform certain roles. However, the “˜unit” is not limited to software or hardware. The “˜unit” may be configured to reside on an addressable storage medium or may be configured to cause one or more processors to be regenerated. Thus, as an example, the “˜unit” includes components such as software components, object-oriented software components, class components, and task components, and processes, functions, attributes, procedures, subroutines, segments of program code, drivers, firmware, microcode, circuits, data, databases, data structures, tables, arrays, and variables. Functionality provided within the components and “˜units” may be combined into a smaller number of components and “˜units” or further separated into additional components and “˜units.” Additionally, the components and “˜units” may be implemented to reproduce one or more CPUs within a device or secure multimedia card.

An electric vehicle charging/discharging management device according to an embodiment can learn a driver's schedule and vehicle information through a driver's terminal and automatically establish a vehicle charging/discharging plan according to a linked pattern.

Thus, it is possible to learn a driver's schedule and lifestyle pattern to automatically set an optimized charging/discharging strategy, maximize driver convenience, extend a vehicle's battery life, and reduce energy costs.

Additionally, like routine functions, it is possible to automate charging or discharging actions according to the driver's schedule.

Although the present disclosure has been described above with reference to preferred embodiments thereof, it may be understood by those skilled in the art that various modifications and changes may be made to the present disclosure without departing from the spirit and scope of the present disclosure as set forth in the claims below.

What is claimed is:

1. An electric vehicle charging and discharging management device for an electric vehicle, comprising:
a communication unit configured to collect vehicle information and a driver's schedule;
a memory storing computer-readable instructions;
a first processor configured to access the memory and execute the instructions, wherein the instructions comprise learning a linked pattern according to the vehicle information and the driver's schedule; and
a second processor configured to access the memory and execute the instructions, wherein the instructions comprise setting a charging mode of the electric vehicle according to the linked pattern when the vehicle information and the driver's schedule are input.

2. The device of claim 1, wherein the vehicle information includes plug-in charger information, a current state of charge (SoC), a target SoC, source type information, battery capacity information, battery charging and discharging efficiency, expected vehicle entry time information, expected vehicle exit time information, a plug-in time, and a plug-out time.

3. The device of claim 1, wherein the driver's schedule includes a driving schedule, time information, departure information, and destination information.

4. The device of claim 1, wherein the instructions of the first processor further comprise outputting result data obtained by probabilistically determining a correlation between a lifestyle pattern, a use pattern of a vehicle, and a charging and discharging pattern based on the driver's schedule as the linked pattern.

5. The device of claim 4, wherein the instructions of the second processor further comprise setting a plurality of charging parameters for each charging mode of a plurality of charging modes.

6. The device of claim 5, wherein the plurality of charging parameters include a minimum battery amount and a target battery amount.

7. The device of claim 4, wherein the instructions of the second processor further comprise setting the charging mode for battery protection charging to a first charging mode according to the linked pattern learned from the first processor.

8. The device of claim 4, wherein the instructions of the second processor further comprise setting the charging mode by comparing a vehicle usage probability according to the driver's schedule with a preset threshold value.

9. The device of claim 4, wherein instructions of the second processor further comprise setting the charging mode by a location of the vehicle according to the driver's schedule and comparing a charging and discharging probability of the vehicle with a preset threshold value.

10. The device of claim 4, wherein the instructions of the second processor further comprise setting the charging mode by comparing a probability of use of the vehicle according to the driver's schedule and a probability for a vehicle traveling distance with a preset threshold value.

11. A charging and discharging management method for an electric vehicle, the method comprising:
collecting, by a communication unit, vehicle information and a driver's schedule;
providing a memory storing computer-readable instructions, a first processor configured to access the memory and execute the instructions, and a second processor configured to access the memory and execute the instructions, wherein the instructions comprise
learning, by the first processor, a linked pattern according to the vehicle information and the driver's schedule, and
setting, by the second processor, a charging mode of the electric vehicle according to the linked pattern when the vehicle information and the driver's schedule are input.

12. The method of claim 11, wherein the vehicle information includes plug-in charger information, a current SoC, a target SoC, source type information, battery capacity information, battery charging and discharging efficiency, expected vehicle entry time information, expected vehicle exit time information, a plug-in time, and a plug-out time.

13. The method of claim 11, wherein the driver's schedule includes a driving schedule, time information, departure information, and destination information.

14. The method of claim 11, wherein the instructions further comprise outputting, via the first processor, result data obtained by probabilistically determining a correlation between a lifestyle pattern, a use pattern of a vehicle, and a charging and discharging pattern based on the driver's schedule as the linked pattern.

15. The method of claim 14, wherein the instructions further comprise setting, via the second processor, a plurality of charging parameters for each charging mode of a plurality of charging modes.

16. The method of claim 15, wherein the plurality of charging parameters include a minimum battery amount and a target battery amount.

17. The method of claim 14, wherein the instructions further comprise setting, via the second processor, the charging mode for battery protection charging to a first charging mode according to the linked pattern learned from the first processor.

18. The method of claim 14, wherein the instructions further comprise setting, via the second processor, the charging mode by comparing a vehicle usage probability according to the driver's schedule with a preset threshold value.

19. The method of claim 14, wherein the instructions further comprise setting, via the second processor, the charging mode by a location of the vehicle according to the driver's schedule and comparing a charging and discharging probability of the vehicle with a preset threshold value.

20. The method of claim 14, wherein the instructions further comprise setting, via the second processor, the charging mode by comparing a probability of use of the vehicle according to the driver's schedule and a probability for a vehicle traveling distance with a preset threshold value.
